(19) United States
(12) Patent Application Publication
(10) Pub. No.: US 2012/0286570 A1
(43) Pub. Date: Nov. 15, 2012

(54) POWER DISTRIBUTION ARCHITECTURE FOR DUAL INTEGRATED CORE ENGINE TRANSCEIVER FOR USE IN RADIO SYSTEM

(75) Inventors: Boris Radovcic, Rockaway, NJ (US); Christopher O'Bara, Lake Hiawatha, NJ (US)

(73) Assignee: BAE Systems Information and Electronic Systems Integration Inc., Nashua, NH (US)

(21) Appl. No.: 13/465,250

(22) Filed: May 7, 2012

Related U.S. Application Data
(60) Provisional application No. 61/484,036, filed on May 9, 2011.

(51) Int. Cl. H02J 1/00

(52) U.S. Cl. 307/11

(57) ABSTRACT

A method and apparatus of using DICE-T personality cards to adapt the incoming voltages supplied by the GVA and provide the ability to turn any voltage to any card on or off depending upon operating mode in a radio system is disclosed. The ability to control voltages individually also allows the control of the power-up sequencing of any card. The DICE-T personality cards use voltages from GVA to generate the additional voltages required by the Core Engines and VHF Module. All of the voltages are connected to hot-swap controllers which provide switching of the power to each destination. These hot-swap controllers also provide monitoring of voltage and shut-down if over-current conditions occur. The two DICE-T personality cards each have a Complex Programmable Logic Device (CPLD) controls the hot-swap controller for each voltage. The CPLD also controls the sequencing of the individual voltages applied to each module.

### CROSS-REFERENCE TO RELATED APPLICATIONS

This Application claims rights under 35 USC §119(e) from U.S. application Ser. No. 61/484,036 filed May 9, 2011, the contents of which are incorporated herein by reference.

### TECHNICAL FIELD

Embodiments are generally related to radio systems. Embodiments are also related to methods for power distribution in radio systems. Embodiments are additionally related to power distribution architecture for Dual Core Integrated Core Engine Transceiver (DICE-T) for use in radio system. Embodiments are additionally related to method and apparatus of using DICE-T personality cards to adapt incoming voltages supplied by GVA and provide ability to turn any voltage to any card on or off depending upon operating mode.

### BACKGROUND OF THE INVENTION

Radio systems have many modular electronics systems for providing radio communications to and from vehicles for example military vehicles and the like. The existing Ground Mobile Radio (GMR) Ground Vehicle Aerodynamics (GVA) was designed to accommodate modules such as power amplifiers, transceivers, and Platform Interface Modules (PIM). In such radio systems a Dual Integrated Core Engine Transceiver (DICE-T) hardware or similar devices many have different voltages and power sequencing, requirements. This stringent power requirement to various modules. For example, the GVA has to supply different voltage to two Core Engines and VHF Module of the DICE-T.

The voltage requirements to various modules vary depending on the operating mode. For example voltages supplied to these modules vary during transmission and reception. The power architecture utilized in prior art radio systems, does not meet the different voltage and power sequencing requirements. Such systems supply voltages to all modules or not supply voltages to the required modules depending on operating mode. This maximizes the power consumption of the system. When a voltage is applied to a module without all the other required voltages applied, a serious damage to the module can occur. Also such prior art systems do not allow individual control of voltages supplied to each modules.

A need, therefore, exists for an apparatus to adapt the incoming voltages supplied by the GVA and provide the ability to turn any voltage to any module or card on or off depending upon operating mode. Also such apparatus should be ability to control voltages individually and also allows the control of the power-up sequencing of any card.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for radio systems.

It is another aspect of the disclosed embodiments to provide for methods for power distribution in radio systems. Embodiments are additionally related to power distribution architecture for dual core integrated core engine transceiver for use in radio system.

It is a further aspect of the present invention to provide for method and apparatus of using DICE-T personality cards to adapt incoming voltages supplied by GVA and provide ability to turn any voltage to any card on or off depending upon operating mode.

It is another aspect of the present invention to provide for method and apparatus of using DICE-T personality cards having ability to control voltages individually supplied to various modules in a radio system.

It is a yet another aspect of the present invention to provide for method and apparatus of using DICE-T personality cards which allows control of the power-up sequencing of any card used in a radio system.

The aforementioned aspects and other objectives and advantages can now be achieved as described herein. The DICE-T personality cards in a radio system use voltages from GVA to generate additional voltages required by the Core Engines and VHF Module. All of the voltages are connected to hot-swap controllers which provide switching of the power to each destination. These hot-swap controllers also provide monitoring of voltage and shut-down if over-current conditions occur. The two DICE-T personality cards each have a Complex Programmable Logic Device (CPLD) controls the hot-swap controller for each voltage. The CPLD also controls the sequencing of the individual voltages applied to each module.

On Initial power-up and de-assertion of power-up-reset, the DICE CPLDs enable 3.6V and 5V to the Core Engine modems. The application of voltages to the RF hardware is then controlled by a SPI serial bus between each CPLD and the modem's processor. This serial bus is used to command the power-up of the Core Engine RF and the VHF Module when required. Since the 28V to the RF hardware is only required during transmit, the Core Engine modem has individual control of this voltage over the SPI bus. The Core Engine modem only enables modules as they are required for the current operating mode thereby minimizing power consumption.

The CPLD control also provides a measure of safety in a radio system. When voltage is applied to the RF hardware without all the other required voltages applied, serious damage to the RF hardware can occur. The CPLD logic prevents this by monitoring the hot-swap controllers' “power-good” signals for the other voltages to the RF hardware. If any of these voltages droop too low or fail entirely, the voltage applied to the RF hardware is turned off within nanoseconds.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a simplified block diagram of an apparatus for power distribution in radio systems, in accordance with the disclosed embodiments;

FIG. 2 illustrates a schematic diagram of DICE-T personality cards depicted in FIG. 1, in accordance with the disclosed embodiments;

FIG. 3 illustrates a block diagram of DICE-T personality cards connected to controllers, in accordance with the disclosed embodiments;

FIG. 4 illustrates a block diagram of DICE-T personality cards and controller utilized for controlling a voltage 3.6V, in accordance with the disclosed embodiments;

FIG. 5 illustrates a block diagram of CPLD control of individual modules, in accordance with the disclosed embodiments;

FIG. 6 illustrates a detailed block diagram of DICE-T personality cards depicted in FIG. 1, in accordance with the disclosed embodiments;

FIG. 7 illustrates a flow chart showing a method of distributing power in a radio system, in accordance with the disclosed embodiments; and

FIG. 8 illustrates a flow chart showing a method of utilizing CPLDs for safety operation of radio system, in accordance with the disclosed embodiments;

### DETAILED DESCRIPTION

The particular values and configurations discussed in these non-limiting examples can be varied and are cited merely to illustrate at least one embodiment and are not intended to limit the scope thereof.

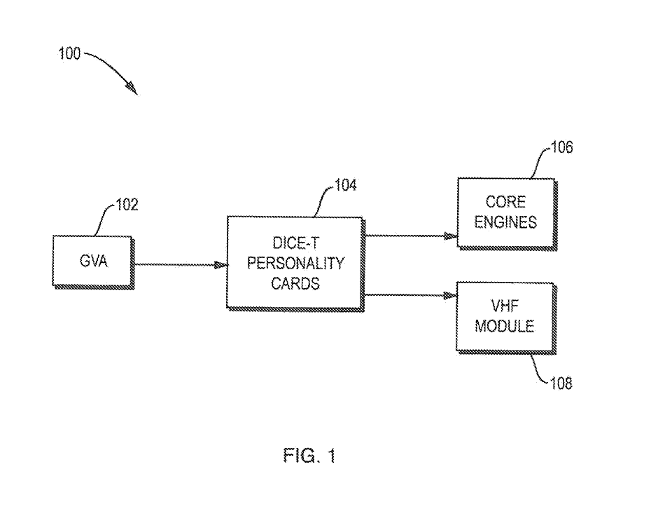

FIG. 1 illustrates a simplified block diagram of an apparatus 100 for power distribution in radio systems, in accordance with the disclosed embodiments. The apparatus 100 has DICE-T personality cards 104 for generating and supplying voltages to various modules such as Core Engines 106 and the VHF Module 108 in a radio system. DICE-T personality cards 104 adapt the available voltages from the Ground Vehicle Adapter (GVA) 102 to the voltages required by two Core Engines 106 and the VHF Module 108. The GVA 102 supplies voltages such as 3.3V, 5V 8V and 12V to DICE-T personality cards 104 and has limits on the current that can be drawn from each voltage. The DICE-T personality cards 104 use these voltages to generate the additional voltages required by the Core Engines 106 and VHF Module 108.

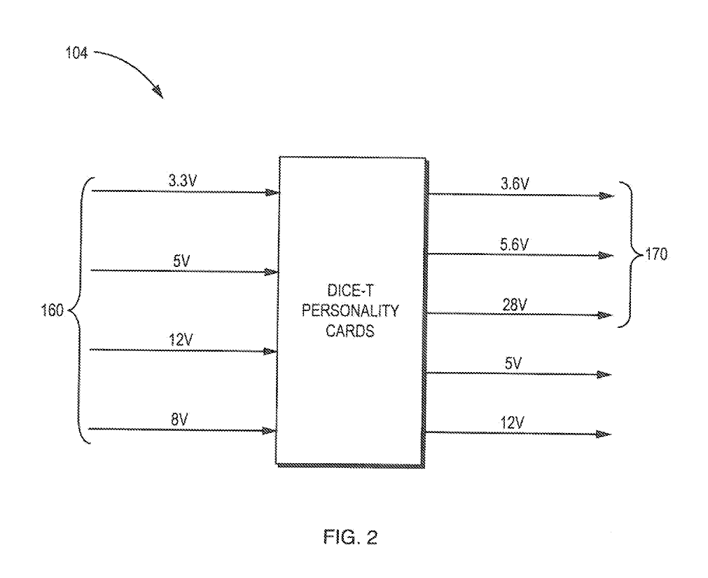

FIG. 2 illustrates a schematic diagram of DICE-T personality cards depicted in FIG. 1, in accordance with the disclosed embodiments. The DICE-T personality cards 104 use voltages 160 such as 3.3V, 5V 8V and 12V from GVA 102 depicted in FIG. 1 to generate the additional voltages 170 such as 3.6V, 5.6V, and 28V required by the Core Engines 106 and VHF Module 108 depicted in FIG. 1.

Note that Dual Integrated Core Engine Transceiver (DICE-T) hardware or similar devices utilizes the additional voltages generated by DICE-T personality cards to meet different voltages and power sequencing requirements in radio systems. Also the apparatus provide the ability to turn any voltage to any card on or off depending upon operating mode. The ability to control voltages individually also allows the control of the power-up sequencing of any card.

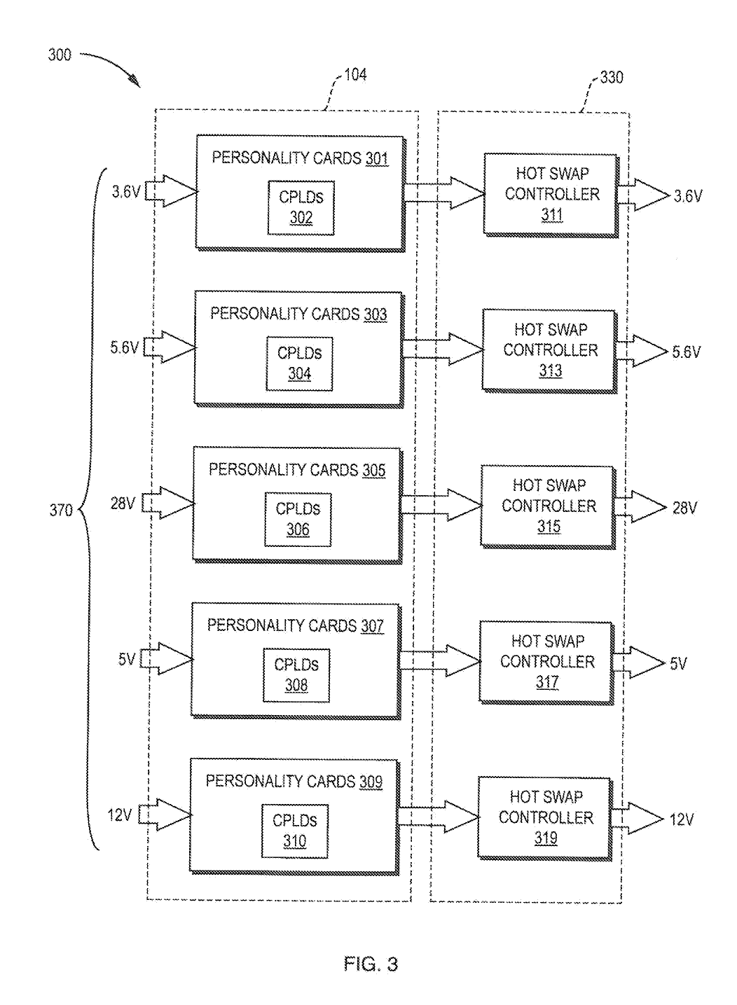

Referring to FIG. 3, a block diagram of DICE-T personality cards 104 depicted in FIG. 1 connected to controllers 330 is disclosed. All of the voltages 370 such as 3.6V, 5.6V, 28V, 5V and 12V are connected to hot-swap controllers 330 which provide switching of the power to each destination. These hot-swap controllers 330 also provide monitoring of voltage and shut-down if over-current conditions occur.

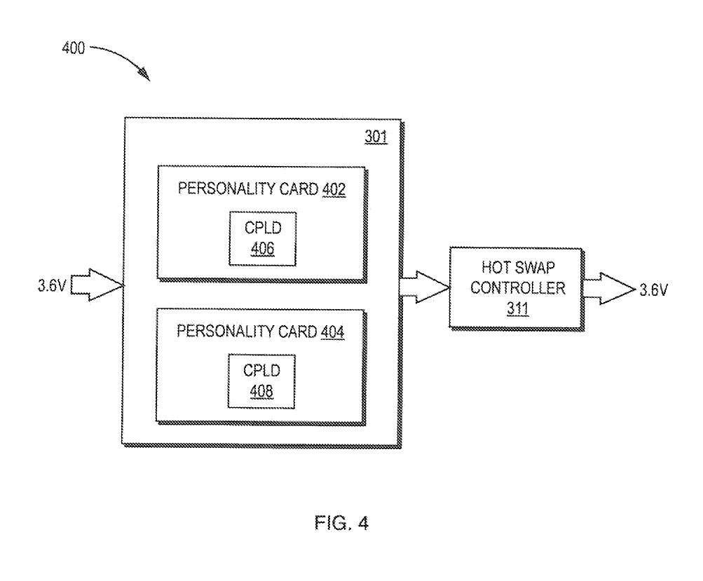

Programmable logic devices (PLDs) exist as a well-known type of Integrated Circuit (IC) that can be programmed by a user to perform specified logic functions. The PLDs can be of programmable logic arrays (PLAs) or Complex Programmable Logic Devices (CPLDs). The two DICE-T personality cards each having a Complex Programmable Logic Device (CPLD) controls the hot-swap controller for each voltage. FIG. 4 illustrates the personality cards 301 and a hot swap controller 311 utilized for 3.6V depicted in FIG. 3. Each voltage say voltage 3.6V is connected to two personality cards 402 and 404 each have a CPLD 406 and 408. Similarly two personality cards each have a CPLD controls a hot swap controller for a voltage. The CPLD also controls the sequencing of the individual voltages applied to each module.

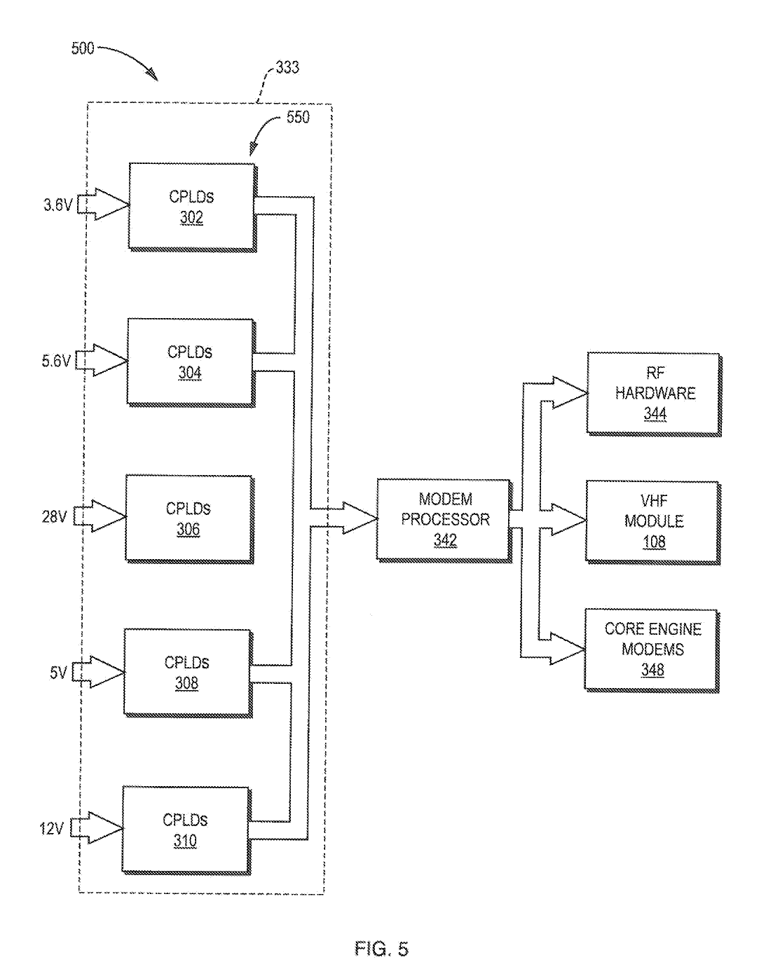

FIG. 5 illustrates a block diagram of CPLD control of individual modules, in accordance with the disclosed embodiments. On Initial power-up and de-assertion of power-up-reset, the DICE CPLDs 302 and 306 enable 3.6V and 5V to the Core Engine modems 348. The application of voltages to the RF hardware 344 is then controlled by a SPI serial bus 550 between each CPLD 333 and the modem's processor 342. This serial bus 550 is used to commend the power-up or power-on of the RF hardware 344 and the VHF Module 346 when required. Since the 28V to the RF hardware 344 is only required during transmit, the Core Engine modem has individual control of this voltage over the SPI bus. The Core Engine modem 348 only enables modules as they are required for the current operating mode thereby minimizing power consumption.

The CPLD control also provides a measure of safety. If 28V is applied to the RF hardware without all the other required voltages applied, serious damage to the RF hardware can occur. The CPLD logic prevents this by monitoring the hot-swap controllers' “power-good” signals for the other voltages to the RF hardware. If any of these voltages droop too low or fail entirely, the 28V is turned off within nanoseconds.

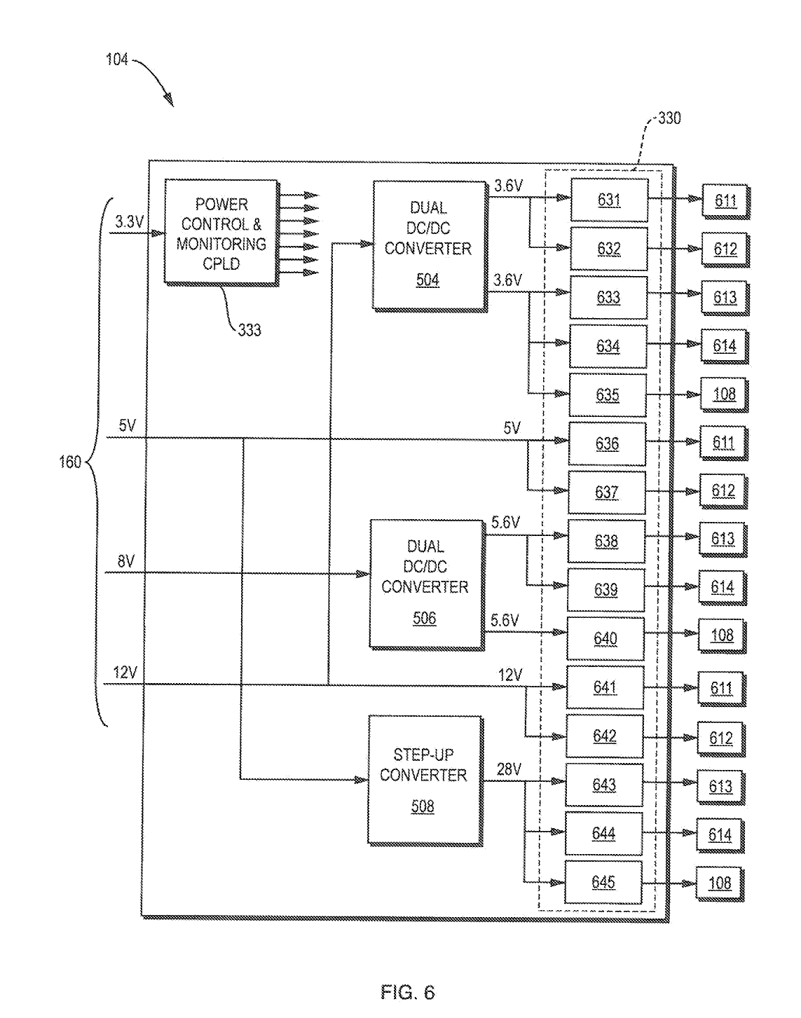

FIG. 6 illustrates a detailed block diagram of DICE-T personality cards 104 depicted in FIG. 1, in accordance with the disclosed embodiments. The DICE-T personality cards 104 receive voltages 160 such as 3.3V, 5V, 8V and 12V from GVA 102 depicted in FIG. 1 and generate additional voltages such as 3.6V, 5.6V and 28V. The additional voltages such as 3.6V, 5.6V and 28V along with voltages such as 5V and 12V from GVA are supplied to core engines 106 and VHF module 108 depicted in FIG. 1. The CPLD 333 controls power-up sequencing of individual voltages applied to each module. The CPLD 33 also monitors hot swap controller 330 for providing a measure of safety in radio systems. The hot swap controller 330 has a plurality of switch circuits 631-645 to provide switching of the power to the destinations 611-625 respectively.

The DICE-T personality cards 104 have a VHF module and a dual core engines. The dual core engine has first core engine and second core engine. The first core engine has a core engine first modem and a core engine first RF. The second core engine has a core engine second modem and a core engine second RF. The switch circuits 631-635 supplies 3.6 V to the core engine first modem 611, the core engine second modem 612, the core engine first RF 613, the core engine second RF 614 and the VHF module 108 respectively. The switch circuits 631-635 receive 3.6V from a dual DC/DC converter 504 which converts direct current voltage 12V from GVA to direct current voltage 3.6V.

The switch circuits 636 and 637 supplies voltage 5V to the core engine first modem 611 and the core engine second modem 612 directly from GVA. The switch circuits 638-640 supplies 5.6 V to the core engine first RF 613, the core engine second RF 614 and the VHF module 108 respectively. The switch circuits 638-640 receive 5.6V from a dual DC/DC converter 504 which converts direct current voltage 8V from GVA to direct current voltage 5.6V. The switch circuits 641 and 642 supplies voltage 12V to the core engine first RF 613 and the core engine second RF 614 respectively directly from GVA. A set-up converter 508 increases voltage 5V from GVA to voltage 28V and through switch circuits 643-645 voltage 28V is supplied to the core engine first RF 613, the core engine second RF 614 and the VHF module 108 respectively.

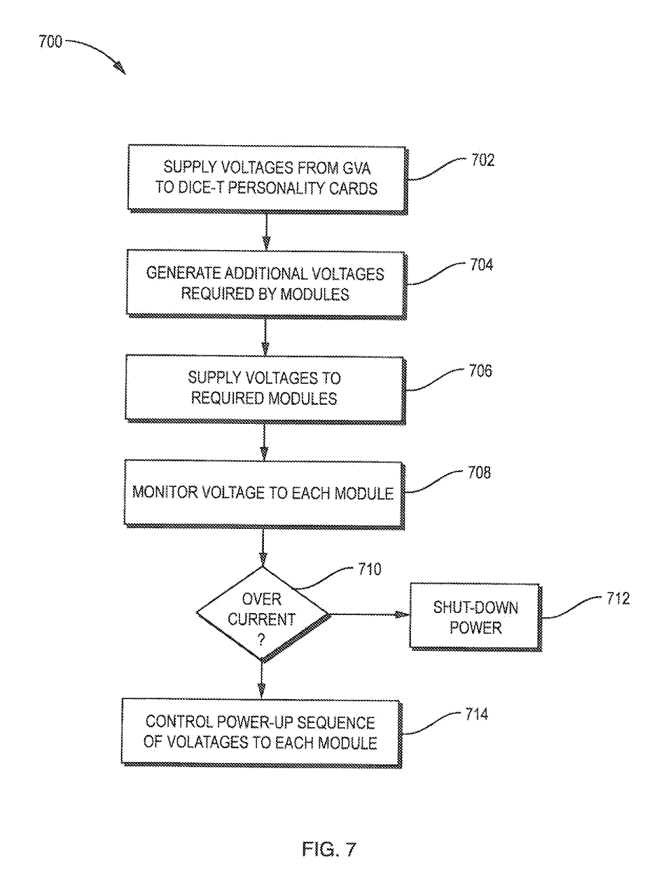

FIG. 7 illustrates a flow chart 700 showing a method of distributing power in a radio system, in accordance with the disclosed embodiments. As illustrated at block 702, voltages from GVA are supplied to DICE-T personality cards. The DICE-T personality cards generate additional voltages required by two Core Engines and the VHF Module as said at block 704. As said at block 706 the generated voltages are supplied to two Core Engines and the VHF Module depending on the operating mode. The hot swap controller provides switching of the power and monitoring voltage to each module as depicted at block 708. As illustrated at block 710, on detecting the over-current condition to modules, the power to the modules is shut-down. Else the CPLDs in DICE-T personality cards control power-up sequence of voltages to each module as said at block 714.

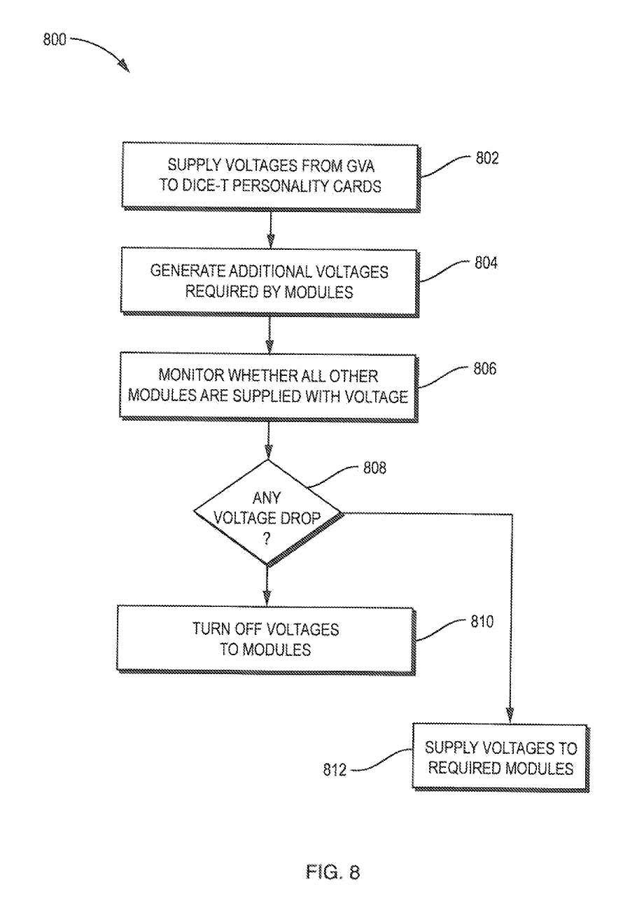

Referring to FIG. 8, a flow chart 800 showing a method of utilizing CPLDs for safety operation of radio system is disclosed. As depicted at block 802, voltages from GVA is supplied to DICE-T personality cards. Then, additional voltages required by two Core Engines and the VHF Module are generated as said at block 804. Monitor whether all other modules are supplied with voltage depending on an operating mode as illustrated at block 806. As illustrated at blocks 808, on detecting the voltage drop, voltages to modules depending on the operating mode is turned off. Else the voltages to required modules are supplied as said at block 812.

It will be appreciated that variations of the above disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for power distribution in radio systems comprising:
supplying voltages from a ground vehicle adapter to a plurality of personality cards;
generating additional voltages required by a plurality of modules in said radio system;
supplying voltages to said plurality of modules;
monitoring voltages to each voltage; and
controlling of power-up sequencing of voltages to said plurality of modules.

2. The method of claim 1 wherein power-up sequencing of voltages to said plurality of modules are controlled depending on operating mode.

3. The method of claim 1 wherein power to at least one said plurality of modules is shut-down on detecting over current depending on operating mode.

4. The method of claim 1 wherein voltages are connected to a plurality of hot-swap controllers for providing switching of the power to said plurality of modules.

5. The method of claim 1 wherein said plurality of hot-swap controllers provides monitoring of voltage and shut-down on detecting over-current conditions.

6. The method of claim 1 wherein said, plurality of personality cards each having a complex programmable logic device controls each said plurality of hot-swap controllers for each voltage.

7. The method of claim 1 wherein said complex programmable logic device controls sequencing of the individual voltages applied to each module.

8. The method of claim 1 wherein said complex programmable logic device turn-off voltages to said plurality of modules on detecting voltage drop in any said plurality of modules depending on operating mode.

9. The method of claim 1 wherein said plurality of personality cards comprises dual integrated core engine transceiver personality cards.

10. A system for power distribution in radio systems comprising:
a plurality of personality cards for supplying voltages from a ground vehicle adapter to a plurality of modules, wherein said plurality of personality cards generates additional voltages required by a plurality of modules in said radio system;
a plurality of hot-swap controllers connected to voltages from said plurality of personality cards for proving switching of power to said plurality of modules; and
a plurality of complex programmable logic devices in said plurality of personality cards for controlling said plurality of hot-swap controllers.

11. The system of claim 10 wherein said plurality of complex programmable logic devices controls power-up sequencing of voltages to said plurality of modules.

12. The system of claim 10 wherein power-up sequencing of voltages to said plurality of modules are controlled depending on operating mode.

13. The system of claim 10 wherein power to at least one said plurality of modules is shut-down on detecting over current depending on operating mode.

14. The system of claim 10 wherein said plurality of hot-swap controllers provides monitoring of voltage and shut-down on detecting over-current conditions.

15. The system of claim 10 wherein at least one said plurality of complex programmable logic devices controls at least one said plurality of hot-swap controllers for at least one voltage.

16. The system of claim 10 wherein said plurality of complex programmable logic devices control sequencing of individual voltages applied to each module.

17. The system of claim 10 wherein said complex programmable logic device, turn-off voltages to said plurality of modules on detecting voltage drop in any said plurality of modules depending on operating mode.

18. The system of claim 10 wherein said plurality of personality cards comprises dual integrated core engine transceiver personality cards.

19. A system for power distribution in radio systems comprising:
a plurality of personality cards for supplying voltages from a ground vehicle adapter to a plurality of modules, wherein said plurality of personality cards generates additional voltages required by a plurality of modules in said radio system;
a plurality of hot-swap controllers connected to voltages from said plurality of personality cards for proving switching of power to said plurality of modules; and
a plurality of complex programmable logic devices in said plurality of personality cards for controlling said plurality of hot-swap controllers, wherein said plurality of complex programmable logic devices controls power-up sequencing of voltages to said plurality of modules, and said plurality of modules are controlled depending on operating mode.

20. The system of claim 19 wherein power to at least one said plurality of modules is shut-down on detecting over current depending on operating mode.
